(19) United States
(12) Patent Application Publication
(10) Pub. No.: US 2004/0128360 A1
(43) Pub. Date: Jul. 1, 2004

(54) Channel server

(76) Inventors: Robert Petri, Santa Clara, CA (US); Layne Miller, Campbell, CA (US); Frederic Delley, Fremont, CA (US)

Correspondence Address: Buckley, Maschoff,, Talwalkar & Allison LLC, Five Elm Street, New Canaan, CT, 06840, US

(21) Appl. No.: 10/334,208

(22) Filed: Dec. 31, 2002

(51) Int. Cl. G06F 15/167

(52) U.S. Cl. 709/214

(57) ABSTRACT

According to some embodiments, provided are reception of a work unit and a channel ring Id from a client application, association of the work unit with a channel ring associated with the channel ring Id, passage of the ring Id to a worker thread, acquisition of the work unit associated with the channel ring, performance of a service on the work unit, and transmission of a reply to the client application.

### BACKGROUND

Internet Exchange Architecture (IXA™), developed by Intel Corporation of Santa Clara, Calif., is a packet-processing architecture for use with computer networks such as the Internet. A packet is a unit of data that is routed between an origination network device and a destination network device based on a destination address contained within the packet. IXA encompasses both IXA Network Processors™ and languages for processing such packets.

In a typical network switch, a network classification language is used to initially classify received packets. IXA also provides a user-defined Action Classification Engine (ACE™) to perform more complex post-classification tasks. More particularly, an application developer may utilize Intel's Action Services Library (ASL™) API to access functions provided by ACE modules. These functions may include one or more of encryption, firewall services, Web load balancing, IP forwarding, packet fragmentation, packet scheduling, protocol translation and signaling.

An IXA software development kit (SDK) provides tools for writing client applications that use the ASL API and ACEs to process packets. A client application is a software application that obtains data from a server application. Accordingly, a server application is a software application that provides specific services to a client application.

Server applications may receive simultaneous requests for services from one or more client applications. Such requests are often fulfilled on a “first-come, first-served”basis. For example, a server may be asked, by one or more client applications, to perform a first task, a second task and a third task, in that order. The server application therefore performs the first task, followed by the second task and then the third task. The third task is therefore not begun until after the first and second tasks are complete. Such a scenario may be unsatisfactory, particularly in cases where the time required to complete the third task is brief in comparison to the time required to complete the first and second tasks.

### BRIEF DESCRIPTION OF THE DRAWINGS

FIG. 1 is a functional block diagram of a channel server according to some embodiments.

FIG. 2 is a flow diagram of process steps according to some embodiments.

FIG. 3 is a functional block diagram of a channel server according to some embodiments.

FIG. 4 is a flow diagram of process steps according to some embodiments.

FIG. 5 is a diagram illustrating a system according to some embodiments.

### DETAILED DESCRIPTION

Components and operation of a channel server are described below in terms of IXA SDK components. However, some embodiments may be implemented with components that function in the same manner as the IDX SDK components described herein, or with other types of components.

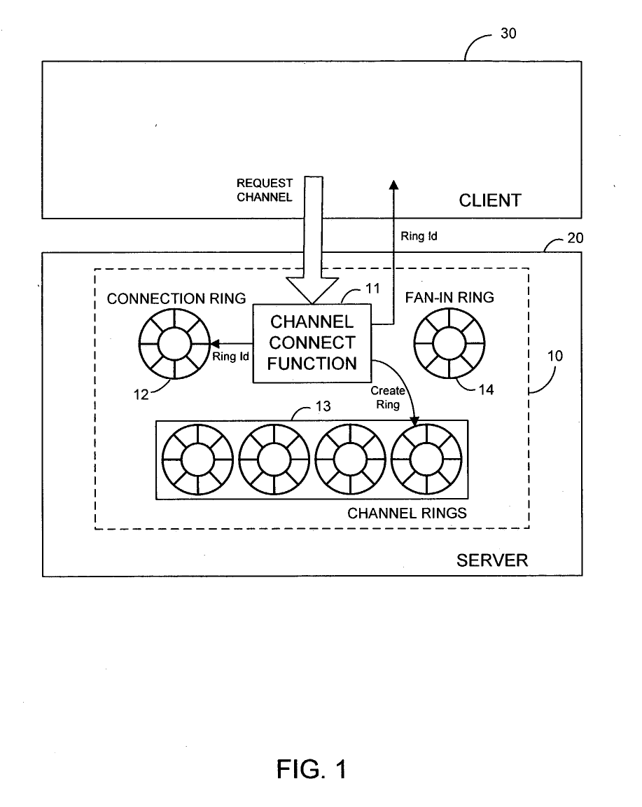

FIG. 1 is a functional block diagram of a channel server according to some embodiments. As shown, channel server 10 is provided by server application (server) 20 and communicates with client application (client) 30. Channel server 10 may be implemented by processor-executable code of the IDX SDK and/or of other code sources.

Channel server 10 includes channel connect function 11, connection ring 12, channel rings 13 and fan-in ring 14. Each of the elements of channel server 10 may be a software construct that is implemented using currently- or hereafter-known techniques for implementing such constructs. For example, channel connect function 11 may be implemented using a processor-executable process steps of a Dynamic Link Library, and each of rings 12 through 14 may be dynamically-allocated data storage areas that function as message queues.

Server 20 provides services to clients such as client 30 in response to requests therefrom. Server 20 may be implemented by any combination of hardware and software, and may comprise one or both of a server software application and a device executing process steps thereof. Client 30 may also comprise a software application and/or device. According to some embodiments, client 30 communicates with server 20 and channel server 10 using the ASL API. As alluded to above, channel server 10 and server 20 may communicate with and/or provide services to a plurality of clients such as client 30.

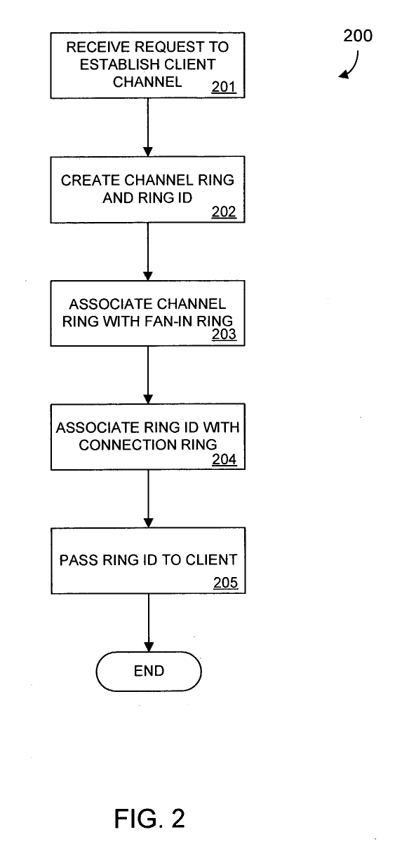

FIG. 1 illustrates a process for establishing a client communication channel according to some embodiments. Briefly, client 30 initially calls a Request Channel API function provided by channel server 10. Channel server 10 executes process steps of channel connect function 11 in response to the call. These steps include a step to create a channel ring associated with client 30 among channel rings 13, a step to create a channel ring Id associated with channel ring, a step to pass the channel ring Id to connection ring 12, a step to associate the ring Id with fan-in ring 14, and a step to pass the ring Id back to client 30. This process will be described in more detail with respect to FIG. 2.

Client 30 may use the channel ring Id as described below to request services from channel server 10. In this regard, the channel ring associated with the channel ring Id represents a unique communication channel between client 30 and server 20.

FIG. 2 is a flow diagram of process steps 200 according to some embodiments. As described above, process steps 200 may be embodied in channel connect function 11 of channel server 10. Process steps 200 may, however, be implemented by any combination of hardware, software or firmware. In some embodiments, process steps 200 are stored in a memory of a network device and executed by a network processor of the network device.

Initially, in step 201, client 30 calls a Request Channel API function provided by channel server 10. Any protocol for calling an API function may be used in step 201, including protocols in which client 30 uses an entry point previously provided by channel server 10. Channel connect function 11 may comprise an ACE associated with the Request Channel function. Accordingly, process steps of channel connect function 11 are then executed in step 202 to create a channel ring associated with the client and a channel ring Id that identifies the created channel ring. FIG. 1 illustrates the creation of a channel ring and the inclusion of the channel ring among existing channel rings 13 in step 202. In some embodiments, the channel ring is created by allocating a circular message queue and the ring Id is a pointer to the message queue.

The channel ring is associated with fan-in ring 14 in step 203. The two rings may be associated with one another by associating a pointer to fan-in ring 14 with the channel ring Id, and/or by storing a pointer to fan-in ring 14 within a memory area allocated to the channel ring. Next, in step 204, the channel ring Id is associated with connection ring 12. Conceptually, the ring Id is “placed” on connection ring 12 in step 204, but may simply be stored in a circular message queue corresponding to connection ring 12.

Finally, in step 205, the channel ring Id is passed back to client 30. Client 30 may use the channel ring Id to communicate with channel server 10. More particularly, the channel ring Id may be used to request services from server 20.

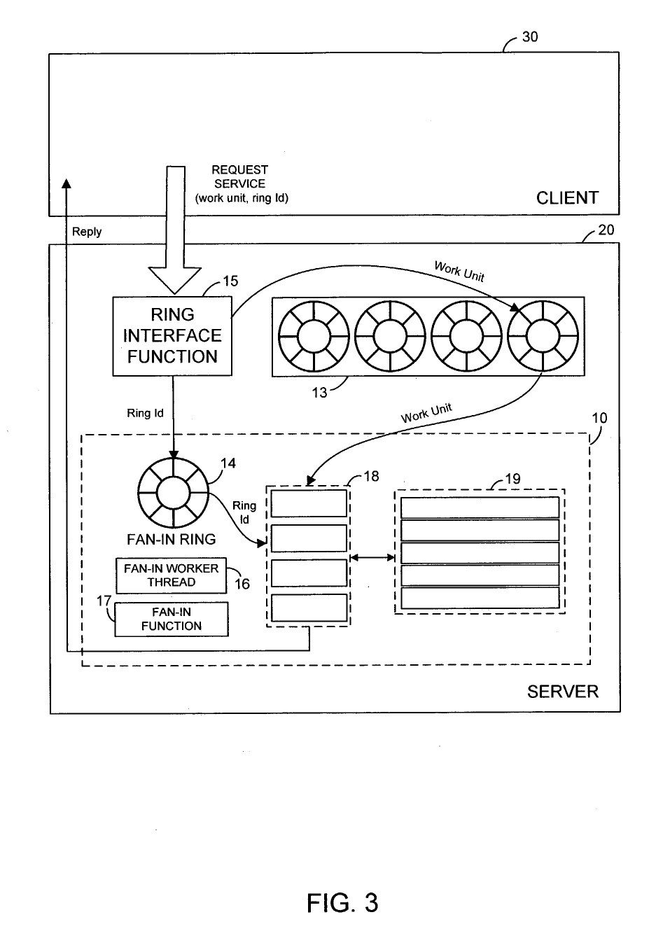

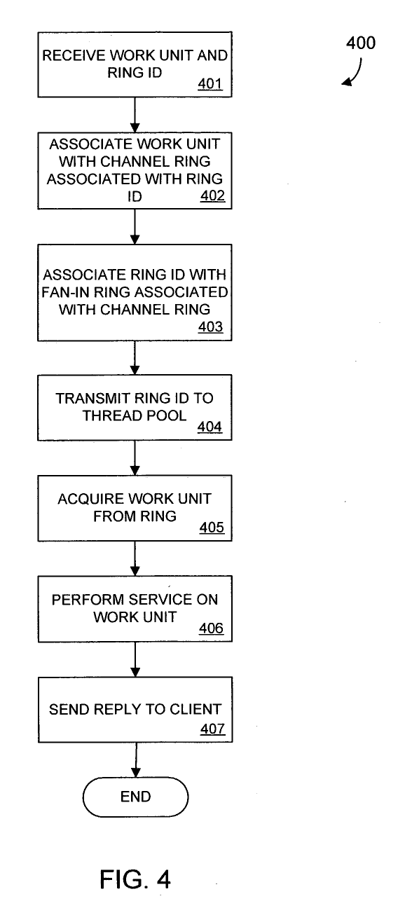

FIG. 3 is a functional block diagram illustrating a process for providing services to client 30 according to some embodiments. Process steps 400 of FIG. 4 will be used to describe the process illustrated in FIG. 3. In this regard, one or more of process steps 400 may be embodied in ring interface function 15 of server 20 and/or channel server 10, and may executed by a network processor of a network device that provides server 20.

A work unit and a channel ring Id are initially received from client 30 in step 401. According to the illustrated embodiment, the work unit and the ring Id are parameters of a Request Service API function call made by client 30 to ring interface function 15. Ring interface function 15 may therefore comprise processor-executable process steps of an ACE that is responsible for handling the Request Service function call. Accordingly, process steps of ring interface function 15 are executed in step 402 to associate the received work unit with a channel ring that is associated with the received ring Id.

In some embodiments, the received channel ring Id points to a memory area allocated to a channel ring that is associated with client 30. The work unit may therefore be associated with the channel ring in step 402 by storing the work unit in the allocated memory area. Step 402 is illustrated in FIG. 3 by an arrow from ring interface function 15 to channel rings 13 labeled “Work Unit”.

Next, the received ring Id is associated in step 403 with a fan-in ring that is, in turn, associated with the subject channel ring. The foregoing description of step 203 indicates several systems by which the channel ring may be associated with a fan-in ring. Accordingly, ring interface function 15 may initially determine in step 403 that fan-in ring 14 is associated with the channel ring by acquiring a pointer to fan-in ring 14 that is stored in the memory area associated with the channel ring. The channel ring Id may then be stored in a circular queue that is pointed to by the acquired pointer, thereby associating the ring Id with fan-in ring 14. Storing the channel ring Id in this manner is demonstrated in FIG. 3 by an arrow from ring interface function 15 to fan-in ring 14 labeled “Ring Id”.

The stored ring Id is transmitted to a pool of worker threads in step 404. In some embodiments of step 404, fan-in worker thread 16 is configured to wake when a ring Id is associated with fan-in ring 14. Upon waking, worker thread 16 utilizes process steps of fan-in function 17 to pass the ring Id to a worker thread of thread pool 18. Thread pool 18 may comprise a circular queue of worker threads created prior to process steps 400, and the worker thread to which the ring Id is passed may be an inactive thread of thread pool 18.

The worker thread uses the channel ring Id to acquire the work unit from the channel ring in step 405. In a case that the channel ring Id is a pointer to a memory area associated with the channel ring, the worker thread merely requests the work unit from an appropriate storage location within the memory area. In some embodiments, worker thread acquires all work units associated with the channel ring in step 405.

The worker thread then performs a service on the acquire work unit(s) in step 406. Any worker thread in thread pool 18 may perform a service by accessing shareable service code modules 19. Code modules 19 may comprise a plurality of independent units of processor-executable process steps which execute in the context of a worker thread in order to perform services on work units. Code modules 19 may be elements of the IXA SDK or may be created by third-parties including a creator of client 30. The latter scenario may be advantageous in a case that client 30 requires special processing of its generated work units.

A result of the work, or reply, is sent from the subject worker thread to client 30 in step 407. The worker thread is then returned to thread pool 18. Process steps 400 therefore may provide a system in which multiple clients efficiently share a set of worker threads. Such systems may therefore provide services for certain tasks more quickly than conventional systems.

Some embodiments of step 405 may require the worker thread to first determine a number of work units that are associated with the channel ring and, if the number is less than or equal to a threshold number, to acquire the number of work units. Alternatively, the worker thread acquires only the threshold number of work units if the number of work units is greater than the threshold number. Such embodiments may prevent a particular client from monopolizing a worker thread by queuing work units on its channel ring faster than they can be served by the worker thread.

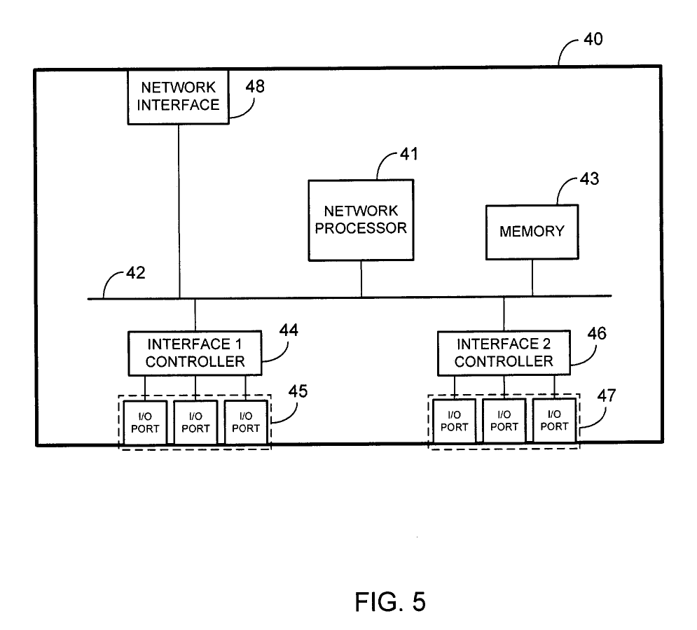

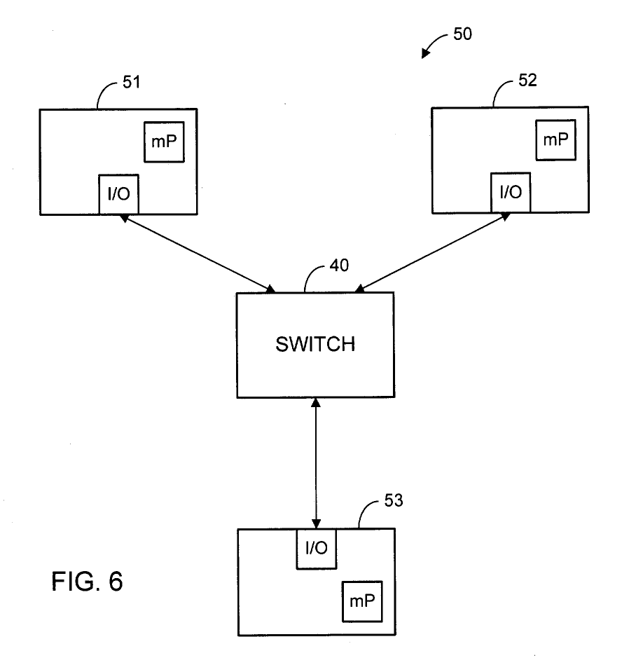

FIG. 5 is a block diagram of a network device according to some embodiments. Network device 40 may comprise a switch for linking several network device to a network. Network device 40 comprises network processor 41, which may be an Intel IXP1200 Network Processor™, coupled to 32-bit PCI bus 42. Also coupled to bus 42 is memory 43, which may comprise Static Read Only Memory or the like. Memory 43 may store process steps that are executable by network processor 41 to perform process steps 200 and/or process steps 400.

The process steps stored in memory 43 may be read from one or more of a computer-readable medium, such as a floppy disk, a CD-ROM, a DVD-ROM, a Zip™ disk, a magnetic tape, or a signal encoding the process steps, and then stored in memory 43 in a compressed, uncompiled and/or encrypted format. In alternative embodiments, hard-wired circuitry may be used in place of, or in combination with, processor-executable process steps for implementation of processes according to embodiments of the present invention. Thus, embodiments of the present invention are not limited to any specific combination of hardware and software.

Interface 1 controller 44 is coupled to bus 42 and provides control over I/O ports 45. I/O ports 45 each support a specific type of interface. Interface 2 controller 46 is also coupled to bus 42 and controls I/O ports 47, which each support an interface type that is different from the interface supported by ports 45. Network interface 48 provides a network connection to network devices coupled to ports 45 and/or 47.

FIG. 6 is a block diagram of a system according to some embodiments. System 50 comprises network switch 40 in communication with network devices 51 through 53. Network devices 51 through 53 may comprise one or more of a desktop computer, a personal digital assistant, a mobile or laptop computer, a cellular or mobile telephone, and any other device usable to access a network. Each of network devices 51 through 53 comprises an I/O port and a microprocessor. The microprocessor may be usable to execute process steps of a client application in order to request services from a channel server of switch 40 as described herein.

Although the links between the illustrated devices are illustrated as a direct connection, any number of physical elements may reside between the devices. More specifically, the links may comprise one or more of any number of different systems for transferring data, including a Local Area Network (LAN), a Metropolitan Area Network (MAN), a Wide Area Network (WAN), a proprietary network, a Public Switched Telephone Network (PSTN), a Wireless Application Protocol (WAP) network, a wireless LAN (e.g., in accordance with the IEEE 802.1 lb standard), a Bluetooth network, an infrared network, and/or an IP network such as the Internet, an intranet or an extranet. Moreover, the links may comprise one or more of any readable medium for transferring data, including coaxial cable, twisted-pair wires, fiber-optics, RF, infrared and the like.

In the foregoing description, numerous specific details are set forth in order to provide a thorough understanding. It will be apparent, however, to one of ordinary skill in the art that some embodiments do not include one or more of these specific details. Moreover, embodiments may include any currently or hereafter-known elements that provide functionality similar to those described above. Therefore, persons of ordinary skill in the art will recognize from this description that other embodiments may be practiced with various modifications and alterations.

What is claimed is:

1. A method comprising:
receiving a work unit and a channel ring Id from a client application;
associating the work unit with a channel ring associated with the channel ring Id;
passing the ring Id to a worker thread;
acquiring the work unit associated with the channel ring;
performing a service on the work unit; and
transmitting a reply to the client application.

2. A method according to claim 1, further comprising:
associating the ring Id with a fan-in ring,
wherein a fan-in ring worker thread wakes in response to the association of the ring Id with the fan-in ring, and
wherein the fan-in ring worker thread passes the ring Id to the worker thread.

3. A method according to claim 1, further comprising:
determining that the fan-in ring is associated with the channel ring Id.

4. A method according to claim 1, wherein the worker thread is an inactive worker thread in a circular worker thread queue.

5. A method according to claim 4, further comprising:
returning the worker thread to the circular worker thread queue.

6. A method according to claim 1, wherein performing the service on the work unit comprises:
determining a number of work units associated with the channel ring;
if the number of work units is less or equal to than a threshold number, performing the service on the work units; and
if the number of work units is greater than the threshold number, performing the service on the threshold number of work units.

7. A processor-readable medium storing processor-executable process steps, the process steps comprising:
a step to receive a work unit and a channel ring Id from a client application;
a step to associate the work unit with a channel ring associated with the channel ring Id;
a step to pass the ring Id to a worker thread;
a step to acquire the work unit associated with the channel ring;
a step to perform a service on the work unit; and
a step to transmit a reply to the client application.

8. A medium according to claim 7, the process steps further comprising:
a step to associate the ring Id with a fan-in ring,
wherein a fan-in ring worker thread wakes in response to the association of the ring Id with the fan-in ring, and
wherein the fan-in ring worker thread passes the ring Id to the worker thread.

9. A medium according to claim 7, the process steps further comprising:
a step to determine that the fan-in ring is associated with the channel ring Id.

10. A medium according to claim 7, wherein the worker thread is an inactive worker thread in a circular worker thread queue.

11. A medium according to claim 10, the process steps further comprising:
returning the worker thread to the circular worker thread queue.

12. A medium according to claim 7, wherein the step to perform a service on the work unit comprises:
a step to determine a number of work units associated with the channel ring;
if the number of work units is less or equal to than a threshold number, a step to perform the service on the work units; and
if the number of work units is greater than the threshold number, a step to perform the service on the threshold number of work units.

13. An apparatus comprising:
a memory storing processor-executable process steps; and
a processor in communication with the memory and operative in conjunction with the stored process steps to:
receive a work unit and a channel ring Id from a client application;
associate the work unit with a channel ring associated with the channel ring Id;
pass the ring Id to a worker thread;
acquire the work unit associated with the channel ring;
perform a service on the work unit; and
transmit a reply to the client application.

14. An apparatus according to claim 13, wherein the processor is further operative in conjunction with the stored process steps to:
associate the ring Id with a fan-in ring,
wherein a fan-in ring worker thread wakes in response to the association of the ring Id with the fan-in ring, and
wherein the fan-in ring worker thread passes the ring Id to the worker thread.

15. An apparatus according to claim 13, wherein the processor is further operative in conjunction with the stored process steps to:
determine that the fan-in ring is associated with the channel ring Id.

16. An apparatus according to claim 13, wherein the worker thread is an inactive worker thread in a circular worker thread queue.

17. An apparatus according to claim 16, wherein the processor is further operative in conjunction with the stored process steps to:
return the worker thread to the circular worker thread queue.

18. An apparatus according to claim 13, wherein the step to perform the service on the work unit comprises:
a step to determine a number of work units associated with the channel ring;
if the number of work units is less or equal to than a threshold number, a step to perform the service on the work units; and
if the number of work units is greater than the threshold number, a step to perform the service on the threshold number of work units.

19. A medium storing processor-executable process steps, the process steps to provide:
a fan-in ring;
a fan-in worker thread associated with the fan-in ring;
a ring interface function to receive a work unit and a channel ring Id from a client application, to associate the work unit with a channel ring associated with the channel ring Id, and to associate the channel ring Id with the fan-in ring; and
a worker thread pool comprising a plurality of worker threads, one of the plurality of worker threads to receive the channel ring Id from the fan-in worker thread, to acquire the work unit associated with the channel ring associated with the channel ring Id, to perform a service on the work unit, and to transmit a reply,
wherein the fan-in worker thread passes the channel ring Id to the one of the plurality of worker threads in response to the association of the channel ring Id with the fan-in ring.

20. A medium according to claim 19, wherein the one of the plurality of worker threads is to determine a number of work units associated with the channel ring, to perform services on the number of work units if the number of work units is less or equal to than a threshold number, and to perform services on a threshold number of work units if the number of work units is greater than the threshold number.

21. A system comprising:
a plurality of network devices; and
a switch in communication with the plurality of network devices, wherein the switch comprises:
a memory storing processor-executable process steps; and
a processor in communication with the memory and operative in conjunction with the stored process steps to:
receive a work unit and a channel ring Id from a client application;
associate the work unit with a channel ring associated with the channel ring Id;
pass the ring Id to a worker thread;
acquire the work unit associated with the channel ring;
perform a service on the work unit; and
transmit a reply to the client application.

22. A system according to claim 21, wherein the processor is further operative in conjunction with the stored process steps to:
associate the ring Id with a fan-in ring,
wherein a fan-in ring worker thread wakes in response to the association of the ring Id with the fan-in ring, and
wherein the fan-in ring worker thread passes the ring Id to the worker thread.

23. A system according to claim 21, wherein the step to perform the service on the work unit comprises:
a step to determine a number of work units associated with the channel ring;
if the number of work units is less or equal to than a threshold number, a step to perform the service on the work units; and
if the number of work units is greater than the threshold number, a step to perform the service on the threshold number of work units.
